(19) United States
(12) Patent Application Publication
(10) Pub. No.: US 2023/0040014 A1
(43) Pub. Date: Feb. 9, 2023

(54) METHOD AND DEVICE FOR CREATING A MACHINE LEARNING SYSTEM

(71) Applicant: Robert Bosch GmbH, Stuttgart (DE)

(72) Inventors: Benedikt Sebastian Staffler, Tuebingen (DE); Jan Hendrik Metzen, Boeblingen (DE); David Stoeckel, Rutesheim (DE)

(21) Appl. No.: 17/873,107

(22) Filed: Jul. 25, 2022

(30) Foreign Application Priority Data
Aug. 4, 2021 (DE) 10 2021 208 453.2

(51) Int. Cl. G06N 20/00; G06K 9/62

(52) U.S. Cl. CPC G06N 20/00; G06K 9/6296

(57) ABSTRACT

A method for creating a machine learning system. The method includes: providing a directed graph including an input node and an output node, a probability being in each case assigned to each edge which characterizes the probability with which an edge is drawn. The probabilities are manipulated as a function of a characteristic degree of an exploration of the architectures of the directed graph prior to a random drawing of the architectures.

### CROSS REFERENCE

The present application claims the benefit under 35 U.S.C. § 119 of German Patent Application No. DE 10 2021 208 453.2 filed on Aug. 4, 2021, which is expressly incorporated herein by reference in its entirety.

### FIELD

The present invention relates to a method for creating a machine learning system, using a graph which describes a plurality of possible architectures of the machine learning system, to a computer program, and to a machine-readable memory medium.

### BACKGROUND INFORMATION

The goal of an architecture search, in particular, for neural networks is to find a preferably good network architecture within the meaning of a key performance indicator/metric for a predefined data set in a fully automatic manner.

To make the automatic architecture search computationally efficient, various architectures may share the weights of their operations in the search space, as is the case, e.g., in a one-shot NAS model, described by Pham, H., Guan, M. Y., Zoph, B., Le, Q. V., & Dean, J. (2018), “Efficient neural architecture search via parameter sharing,” arXiv preprint arXiv:1802.03268.

The one-shot model is typically constructed as a directed graph, in which the nodes represent data, and the edges represent operations, which represent a calculation rule, converting the data of the input node into data of the output node. The search space is made up of subgraphs (e.g., paths) in the one-shot model. Since the one-shot model may be very large, individual architectures from the one-shot model may be drawn for the training, as is described, e.g., by Cai, H., Zhu, L., & Han, S. (2018), “ProxylessNAS: Direct neural architecture search on target task and hardware,” arXiv preprint arXiv:1812.00332. This typically takes place in that an individual path is drawn from an established input node to an output node of the network, as is described, e.g., by Guo, Z., Zhang, X., Mu, H., Heng, W., Liu, Z., Wei, Y., & Sun, J. (2019), “Single path one-shot neural architecture search with uniform sampling,” arXiv preprint arXiv:1904.00420.

In their paper:ProxylessNAS: Direct Neural Architecture Search on Target Task and Hardware,” retrievable online: https://arxiv.org/abs/1812.00332, the authors Cai et al. describe an architecture search which takes hardware properties into consideration.

For the selection of individual paths, in particular, their corresponding architectures, from the one-shot model, probability distributions are introduced, based on which the paths are drawn. This makes it possible to derive individual architectures from the one-shot model. The parameters of the distribution are optimized during the architecture search. Probability distributions are usually introduced via outgoing edges of the nodes. These probability distributions are typically a multinomial distribution, which is parameterized by a real parameter vector (so-called logits), which is normalized to a probability vector, usually using a softmax function, i.e., the entries of the vector sum accumulate to a value of one. The logits of all probability distributions for each node of the supermodel then form a set of architecture parameters, which may be optimized during the architecture search. The optimization of the logits, however, may result in a premature convergence in the architecture space, which does not allow novel architectures to be explored in later phases of the search process.

### SUMMARY

In accordance with the present invention, it is provided to initially promote an exploration of the architectures as a function of a convergence progress during the architecture search. This has the advantage that better architectures may be found in this way.

In a first aspect, the present invention relates to a computer-implemented method for creating a machine learning system, which is preferably used for image processing.

In accordance with an example embodiment of the present invention, the method includes at least the following steps: providing a directed graph including one or multiple input and output nodes, which are connected via a multitude of edges and nodes. The graph, in particular, the one-shot model, describes a supermodel including a plurality of possible architectures of the machine learning system. A variable (α) is in each case assigned to a plurality of edges, which characterizes the probability with which the respective edge may be drawn. As an alternative, the probabilities may be assigned to the nodes. Variables (α) may be logits or already the probabilities. The logits may be mapped onto the value range between zero and one with the aid of a softmax function, these mappings of the logits then being interpreted as probabilities or these mappings describing a multinomial probability distribution.

The probability of the respective edge refers to the possible decisions at a decision point, in particular, all edges which are available as possible decisions at this decision point. This means that the sum across the probabilities of the edges at the respective decision point should cumulatively yield the value of one.

In accordance with an example embodiment of the present invention, thereupon, a random drawing of a multitude of subgraphs takes place by the directed graph as a function of variables (α), in particular, from a probability distribution which is defined by an output of a softmax function applied to the logits. For the drawing, however, variables (α) are changed in the graph as a function of a distribution of values of variables (α) in the graph. In other words, it may be stated that the distribution of variables (α), in particular, of the logits, describes a distribution of the architectures in the search space. And with this, variables (α) characterize a concentration or frequency distribution of the architectures in the search space. The reason is that it has been found that this measure of the concentration of the architectures in a meaningful way describes a degree of an exploration of the directed graph. Variables (α) describe, as stated above, a distribution across architectures in the search space. During the training, the distribution is effectively optimized in such a way that good architectures within the meaning of a cost function, which characterizes a target task of the machine learning system for the architecture search, receive a higher probability. Depending on how uniform or concentrated this distribution is, more or fewer architectures are explored during the drawing. It is therefore provided to regulate the convergence as a function of this measure. As a result of the manipulation of variables (α), it is achieved that the convergence of the architecture search progresses more slowly during a corresponding change of variables (α), effectively achieving an improved exploration of the search space. This means that the convergence is thus controlled as a function of the exploration. The change of variables (α) may thus also be referred to as a relaxation, which softens the decisions strictly according to the actually assigned probabilities during the drawing of the edges, and causes the convergence, in particular, the locating of an optimal architecture, preferably initially to progress with a smaller convergence rate.

It shall be noted that the drawing of a subgraph may take place iteratively. This means that an incremental creation of a subgraph takes place by consecutively drawing the edges, the subsequent edge being randomly selected, at each reached node of the subgraph, from the possible subsequent edges connected to this node, as a function of their assigned probabilities. Furthermore, it shall be noted that a path may be understood as a subgraph of the directed graph, which includes a subset of the edges and nodes of the directed graph, this subgraph connecting the input node to the output node of the directed graph.

Thereupon, in accordance with an example embodiment of the present invention, a training of the machine learning systems corresponding to the drawn subgraphs follows. During training, parameters of the machine learning system and variables (α) are adapted in such a way that a cost function is optimized.

Thereupon, in accordance with an example embodiment of the present invention, a last drawing of a subgraph follows, as a function of the adapted probabilities, and a creation of the machine learning system corresponding to this subgraph. The last drawing of the subgraph in the last step may take place randomly, or the edges having the highest probabilities are deliberately drawn.

In accordance with an example embodiment of the present invention, it is provided that, when a measure of the distribution of the values of variables (α) relative to a measure of a predefined target distribution is greater, variables (α) are changed in such a way that the edges having an essentially identical probability are drawn. This has the advantage that an exploration of the graph continues to be made possible, even when a convergence of the architecture search starts.

Furthermore, in accordance with an example embodiment of the present invention, it is provided that the change of variables (α) takes place as a function of an entropy of the probability distribution of the architectures in the directed graph, and, in particular, a number of training steps which have already been carried out.

The entropy may be understood to mean a measure of the disarray of the architectures in the graph, or the entropy may be interpreted as a measure of a distribution of the architectures in the search space which is defined by the graph. For large graphs, the entropy may be estimated via random samples. The estimated entropy may be ascertained via an expected value using a logarithm of the distributions of the paths/subgraphs in the directed graph. For large graphs, the entropy may be estimated with the aid of Monte Carlo methods, i.e., based on random samples.

In accordance with an example embodiment of the present invention, it is furthermore provided that, when the entropy in the graph is smaller than a predefined target entropy (S_{target}), a parameter (T,ϵ) by which variables (α) are changed is changed in such a way that this parameter effectuates a change of variables (α) so that the probabilities of a drawing is [sic] shifted to a drawing of the edges essentially having the same probability.

Preferably, when the ascertained entropy (S_{new}) is greater than a predefined target entropy (S_{target}), parameter (T,ϵ) is changed in such a way that a change of variables (α) is effectuated, so that the probabilities that the respective edges are drawn are increased, or the variables are changed in such a way that relations between the variables amplify.

This has the advantage that, due to these changes of the probabilities during drawing, it is intervened in a regulating manner into the exploration progress in a particularly simple way in such a way that entropy S_{target} controls the exploration, and thus a premature fixation to a subset of the architectures from the graph is avoided.

Furthermore, in accordance with an example embodiment of the present invention, it is provided that the cost function includes a first function, which assesses a performance capability of the machine learning system with respect to its performance, for example includes an accuracy of a segmentation, object recognition, or the like, and optionally a second function, which estimates a latency period of the machine learning system as a function of a length of the subgraph or a topology or structure of the subgraph and the operations of the edges. As an alternative or in addition, the second function may also estimate a computer resource consumption of the machine learning system.

The created machine learning system is preferably an artificial neural network, which may be configured for the segmentation and object detection in images.

It is furthermore provided that a technical system is activated as a function of an output of the machine learning system. Examples of the technical system are shown in the following description of the figures.

In further aspects, the present invention relates to a computer program, which is configured to carry out the above methods, and to a machine-readable memory medium on which this computer program is stored.

Specific embodiments of the present invention are described hereafter in greater detail with reference to the figures.

### BRIEF DESCRIPTION OF THE DRAWINGS

FIG. 1 shows a schematic representation of a flowchart of one specific example embodiment of the present invention.

FIG. 2 shows a schematic representation of an actuator control system, in accordance with an example embodiment of the present invention.

FIG. 3 shows one exemplary embodiment for controlling an at least semi-autonomous robot, in accordance with the present invention.

FIG. 4 schematically shows one exemplary embodiment for controlling a manufacturing system, in accordance with the present invention.

FIG. 5 schematically shows one exemplary embodiment for controlling an access system, in accordance with the present invention.

FIG. 6 schematically shows one exemplary embodiment for controlling a monitoring system, in accordance with the present invention.

FIG. 7 schematically shows one exemplary embodiment for controlling a personal assistant, in accordance with the present invention.

FIG. 8 schematically shows one exemplary embodiment for controlling a medical imaging system, in accordance with the present invention.

FIG. 9 shows a possible design of a training device, in accordance with an example embodiment of the present invention.

### DETAILED DESCRIPTION OF EXAMPLE EMBODIMENTS

To find good architectures of deep neural networks for a predefined data set, automatic methods for the architecture search may be employed, so-called neural architecture search (NAS) methods. For this purpose, a search space of possible architectures of neural networks is explicitly or implicitly defined.

Hereafter, a calculation graph (the so-called one-shot model) is to be defined for describing a search space, which includes a plurality of possible architectures in the search space as subgraphs. Since the one-shot model may be very large, individual architectures from the one-shot model may be drawn for the training. This takes place, e.g., in that individual paths are drawn from an established input node to an established output node of the network.

In the simplest case, when the calculation graph is made up of a simple chain of nodes, which may each be connected via different operations, it suffices to draw the operation for two consecutive nodes which connects them.

If the one-shot model, more generally speaking, is an arbitrarily directed graph, e.g., a path may be iteratively drawn, in which the start occurs at the input (input node), and then the next node and the connecting edge are drawn, this procedure being iteratively continued to the target node.

The path thus obtained by the drawing, which may correspond to a subgraph of the directed graph, may then be trained in that an architecture is drawn for each mini batch of training data, and the weights of the operations in the drawn architecture are adapted with the aid of a standard gradient step method. The locating of the best architecture may either take place as a separate step after the training of the weights, or be carried out alternately with the training of the weights.

To draw architectures from a one-shot model, a multinomial distribution across the different discrete selection possibilities may be present during the drawing of a path/subgraph, i.e., an architecture of a machine learning system, which may in each case be parametrized by a real value vector named logits, which may be normalized by applying a softmax function to a probability vector. For a discrete selection, a logits vector α=(α₁, . . . , α_{N}) is defined, αᵢ∈R being a real value, and N corresponding to the number of possible decisions. For NAS, the decisions are, for example, decisions which are to be drawn of the edges or [sic] next for the path.

For drawing, the logits vector is normalized using the softmax function σ, the i-th component being calculated as: σᵢ(α)=e^{α}^{ᵢ}/Σₖe^{α}^{ₖ}, probability vector p=σ(α) thus being given.

This probability vector p is used to draw a decision from a multinomial distribution. A decision could be, for example, to select between the outgoing edges for a node in the graph. The drawing of a complete path may necessitate multiple of these decisions.

An optimization of the logits during the NAS process may cause a premature fixation to a smaller search space, better architectures outside this search space possibly not being further explored.

In a first specific embodiment for overcoming the premature fixation of NAS, a so-called epsilon-greedy exploration is provided. This means that a decision is not drawn according to the corresponding logit, but from a uniform distribution, with a probability of ϵ∈[0,1]. In this way, the decision may be selected from all options with the same probability, e.g., in multiple locations in the network, and not based on the probability values which are derived from the corresponding logits vector. Probability ϵ is hereafter referred to as exploration probability.

In a second specific embodiment, a temperature-dependent scaling of the logits is provided. For this purpose, a positive-real parameter T is introduced, which is referred to hereafter as the (exploration) temperature. The logits are then scaled as a function of this temperature, before they are normalized by the softmax function, i.e., the normalization takes on form:

$$p = σ ( \frac{α}{T} ) .$$

In the case of large values of T, all components of the logit vector will be close to zero, and the distribution will thus be essentially uniformly distributed. For T=1, the logit values are unchanged, and the drawing, as a function of the logits, takes place from the distribution defined by the logit vector. For T→0, the random sample approaches the calculation of argmax of the logit vector.

During the architecture search, the exploration probability or the exploration temperature is cooled, i.e., the architecture search is slowly shifted from a broad exploration of the search space at the start of the architecture search to a focused search of promising architectures.

A simple drop of the exploration probability or of the exploration temperature is directly implementable, however makes it necessary to establish a starting value of the exploration probability/temperature as well as a time schedule which establishes how pronounced the drop is to be. However, it is usually not clear how, e.g., an initial starting value is to be selected, and how quickly it is to cool off, since these values are usually application-specific.

It is therefore provided to introduce an auxiliary measure to approximate how concentrated the architecture distribution by the logits in the search space is distributed. Based on this auxiliary measure, the initial starting value of the exploration probability and the temperature may then be estimated. Furthermore, this auxiliary measure makes it possible to control how pronounced the drop is to be. It has been found that an entropy-based auxiliary measure leads to the best results. Preferably, the entropy of the search space is used for this purpose.

A target corridor or a target value of the exploration probability or of the temperature is indirectly planned in that a target corridor or target value of the entropy is determined and then, with the aid of this target entropy (S_{target}), the exploration probability or temperature is accordingly regulated.

However, it may be complex to precisely ascertain the entropy of a large search space, which is why an estimation of the entropy by random samples may be carried out. Furthermore, it is typically also not possible to directly calculate the required exploration probability or exploration temperature in order to achieve a predefined entropy.

For this reason, the following procedure is provided for setting the exploration probability or temperature until a desired entropy is reached:

It shall apply that S_{target} is the target entropy which the search space is to have, d∈[0,1] is a decay factor, and λ∈[0,1) is a smoothing factor, sₘₐₓ∈N is a maximum number of steps, and K is a small constant (e.g., κ=10⁻⁵) and stepcount=0. For example, it is possible to initially select T=1, and an averaged entropy of search space S_{avg} is estimated, e.g., based on a low number of random samples (e.g., 25 random samples). Initially larger values for T are also possible.

The following steps are then carried out iteratively so that, based on the entropy of the search space, a relaxation of the logits is determined:
1. Determining a new estimation of entropy S_{new} of the search space based on a predefined number of random samples (possibly, only by a simple random sample);
2. Updating the overall estimation of the entropy as a function of the new estimation of entropy S_{new}, e.g., via a moving average: S_{avg}←exp(λ log(S_{avg})+(1−λ)log (S_{new}+κ)));
3. Adapting a drop constant γ=1+d^{stepcount};
4. If S_{target}>S_{avg}, then the temperature is adapted as a function of drop constant γ: T←T*γ, otherwise: T←T/γ;
5. Increasing counter stepcount by the value of one. If stepcount ≥sₘₐₓ, the method is terminated; otherwise, the next iteration is started with step 1.

It shall be noted that other moving averages may also be used in step 2, e.g., such as an exponentially moving average or a simple moving average. It shall furthermore be noted that other adaptive control loops may also be used in step 4 to adapt the temperature based on the instantaneous entropy estimation. It shall furthermore be noted that more complex methods for determining the exploration probability/temperature which results in a desired entropy may also be used. One example of this is a noisy-binary search algorithm (https://en.wikipedia.org/wiki/Binary_search_algorithm*Noisy_binary_search or https://www.cs.cornell.edu/˜rdk/papers/karpr2.pdf).

The just described steps 1 through 4 may also be used directly to accordingly adapt exploration probability ϵ. This is done namely in that temperature T is simply replaced by exploration probability ϵ in the above algorithm, and optionally an additional step is introduced, which ensures that ϵ∈[0,1] applies. Preferably, exploration probability ϵ is initially set to a large value, such as 0.9 or 1. In the event that the graph is initialized in such a way that the subgraphs at the beginning are drawn with the same probability, exploration probability ϵ may initially be set to value 0.

The time planning of the exploration probability or temperature then functions as follows. The initial entropy of the architecture distribution is estimated prior to the NAS run, based on, e.g., 1000 random samples, and a decay schedule is selected (e.g., exponential decay). Every time that the planner (scheduler) is retrieved, the new target entropy S_{target} is calculated based on the initial entropy, and the scheduler then determines the required exploration probability or temperature, as described above.

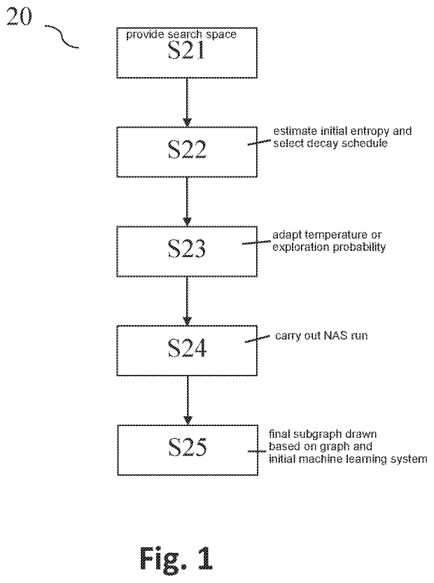

FIG. 1 schematically shows a flowchart (20) of an improved method for the architecture search using a one-shot model.

The automatic architecture search may be carried out as follows. The automatic architecture search first requires a provision of a search space (S21), which may exist here in the form of a one-shot model, logits (α) being assigned to the edges.

In the subsequent step S22, an initial entropy is estimated prior to the application of a NAS method, based on, e.g., 1000 random samples of randomly drawn architectures from the one-shot model, and a decay schedule is selected for the scheduler (e.g., an exponential decay). The decay schedule thereupon ascertains a first target entropy S_{target} as a function of the initial entropy.

After step S22 has ended, step S23 follows. In this step, the temperature or exploration probability ϵ is adapted according to above-described steps 1 through 5.

In the subsequent step S24, an NAS run is carried out using the ascertained parameterization from step S23, i.e., a drawing of subgraphs, using the relaxation of probability distribution p as a function of the ascertained parameter T or ϵ, as well as the training of the machine learning systems corresponding to the subgraphs, etc. It shall be noted that an optimization of the parameters and probabilities during the training may not only take place with respect to the accuracy, but also for specific hardware (e.g., hardware accelerator). This takes place, for example, in that, during the training, the cost function contains a further term, which characterizes the costs for executing the machine learning system with its configuration on the hardware.

After step S24 has ended, step S23, followed by step S24, may be consecutively repeated multiple times. During the repetitions of steps S23 and S24, the scheduler may be retrieved in advance to determine a new target entropy S_{target} based on the initial entropy and the decay schedule. Then, as described above, S23 is used to adapt T, ϵ, and S24 is then carried out again.

The repetition of steps S23 and S24 may, e.g., be aborted when counter stepcount has reached the value of the maximum steps. This means that counter stepcount is used within S23. During each repetition of S23, counter stepcount is initially set back to 0.

Thereafter, in step S25, a final subgraph may be drawn based on the graph, and a corresponding machine learning system may be initialized according to this subgraph.

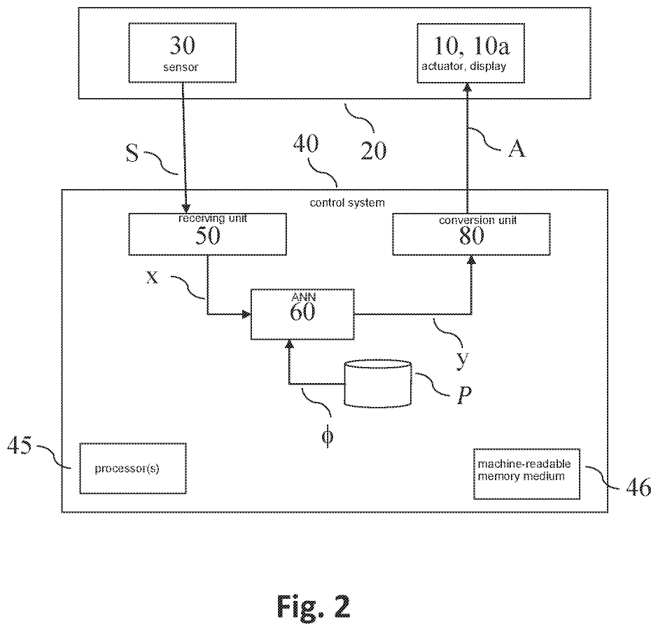

The created machine learning system after step S25 is preferably an artificial neural network 60 (shown in FIG. 2) and is used as described hereafter.

FIG. 2 shows an actuator 10 in its surroundings 20 in interaction with a control system 40. At preferably regular intervals, surroundings 20 are detected in a sensor 30, in particular an imaging sensor, such as a video sensor, which may be provided by a multitude of sensors, for example a stereo camera. Other imaging sensors are also possible, such as for example radar, ultrasound or LIDAR. An infrared camera is also possible. Sensor signal S, or in the case of multiple sensors a respective sensor signal S, of sensor 30 is transmitted to control system 40. Control system 40 thus receives a sequence of sensor signals S. Control system 40 ascertains activation signals A therefrom, which are transferred to actuator 10.

Control system 40 receives the sequence of sensor signals S of sensor 30 in an optional receiving unit 50, which converts the sequence of sensor signals S into a sequence of input images x (alternatively, it is also possible to directly adopt the respective sensor signal S as input image x). Input image x may, for example, be a portion or a further processing of sensor signal S. Input image x includes individual frames of a video recording. In other words, input image x is ascertained as a function of sensor signal S. The sequence of input images x is supplied to a machine learning system, an artificial neural network 60 in the exemplary embodiment.

Artificial neural network 60 is preferably parameterized by parameters □ [sic] which are stored in a parameter memory P and provided thereby.

Artificial neural network 60 ascertains output variables y from the input images x. These output variables y may, in particular, encompass a classification and a semantic segmentation of input images x. Output variables y are supplied to an optional conversion unit 80, which ascertains activation signals A therefrom, which are supplied to actuator 10 to accordingly activate actuator 10. Output variable y encompasses pieces of information about objects which sensor 30 has detected.

Actuator 10 receives activation signals A, is accordingly activated, and carries out a corresponding action. Actuator 10 may include a (not necessarily structurally integrated) activation logic, which ascertains a second activation signal, with which actuator 10 is then activated, from activation signal A.

In further specific embodiments, control system 40 includes sensor 30. In still further specific embodiments, control system 40 alternatively or additionally also includes actuator 10.

In further preferred specific embodiments, control system 40 includes one or multiple processor(s) 45 and at least one machine-readable memory medium 46 on which instructions are stored which, when they are executed on processors 45, prompt control system 40 to execute the method according to the present invention.

In alternative specific embodiments, a display unit 10a is provided as an alternative or in addition to actuator 10.

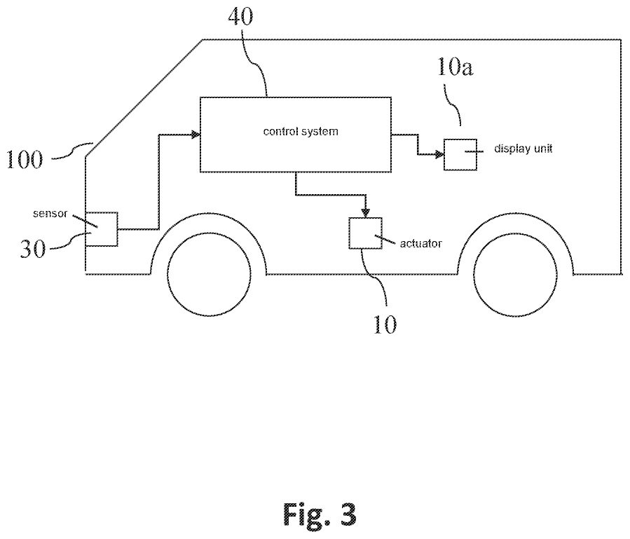

FIG. 3 shows how control system 40 may be used for controlling an at least semi-autonomous robot, here an at least semi-autonomous motor vehicle 100.

Sensor 30 may, for example, be a video sensor preferably situated in motor vehicle 100.

Artificial neural network 60 is configured to reliably identify objects from input images x.

Actuator 10 preferably situated in motor vehicle 100 may, for example, be a brake, a drive or a steering system of motor vehicle 100. Activation signal A may then be ascertained in such a way that actuator or actuators 10 is/are activated in such a way that motor vehicle 100, for example, prevents a collision with the objects reliably identified by artificial neural network 60, in particular, when objects of certain classes, e.g., pedestrians, are involved.

As an alternative, the at least semi-autonomous robot may also be another mobile robot (not shown), for example one which moves by flying, swimming, diving or walking. The mobile robot may, for example, also be an at least semi-autonomous lawn mower or an at least semi-autonomous cleaning robot. Activation signal A may also be ascertained in these cases in such a way that drive and/or steering system of the mobile robot is/are activated in such a way that the at least semi-autonomous robot, for example, prevents a collision with the objects identified by artificial neural network 60.

As an alternative or in addition, display unit 10a may be activated using activation signal A, and, for example, the ascertained safe areas may be represented. It is also possible in the case of a motor vehicle 100 including non-automated steering, for example, that display unit 10a is activated, using activation signal A, in such a way that it outputs a visual or an acoustic warning signal when it is ascertained that motor vehicle 100 is at risk of colliding with one of the reliably identified objects.

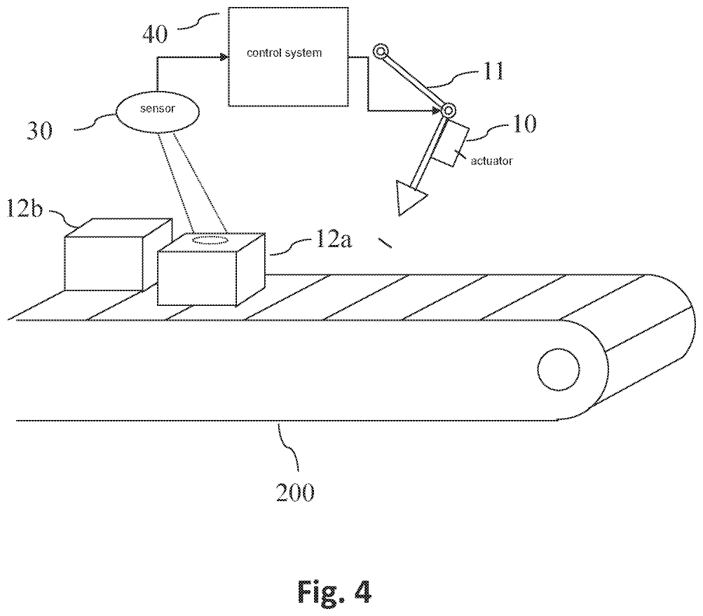

FIG. 4 shows one exemplary embodiment in which control system 40 is used for activating a manufacturing machine 11 of a manufacturing system 200, in that an actuator 10 controlling this manufacturing machine 11 is activated. Manufacturing machine 11 may, for example, be a machine for punching, sawing, drilling and/or cutting.

Sensor 30 may be an optical sensor, for example, which, e.g., detects properties of manufacturing products 12a, 12b. It is possible that these manufacturing products 12a, 12b are movable. It is possible that actuator 10 controlling manufacturing machine 11 is activated as a function of an assignment of the detected manufacturing products 12a, 12b, so that manufacturing machine 11 accordingly executes a subsequent processing step of the correct one of manufacturing products 12a, 12b. It is also possible that manufacturing machine 11 accordingly adapts the same manufacturing step for a processing of a subsequent manufacturing product by identifying the correct properties of the same of manufacturing products 12a, 12b (i.e., without a misclassification).

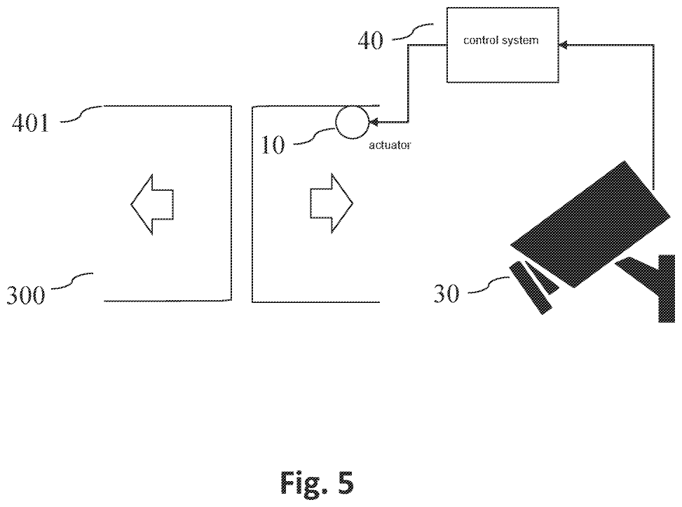

FIG. 5 shows one exemplary embodiment in which control system 40 is used for controlling an access system 300. Access system 300 may encompass a physical access control, for example a door 401. Video sensor 30 is configured to detect a person. This detected image may be interpreted with the aid of object identification system 60. If multiple persons are detected simultaneously, it is possible, for example, to ascertain the identity of the persons particularly reliably by an assignment of the persons (i.e., of the objects) with respect to one another, for example by an analysis of their movements. Actuator 10 may be a lock which unblocks, or does not unblock, the access control as a function of activation signal A, for example opens, or does not open, door 401. For this purpose, activation signal A may be selected as a function of the interpretation of object identification system 60, for example as a function of the ascertained identity of the person. Instead of the physical access control, a logical access control may also be provided.

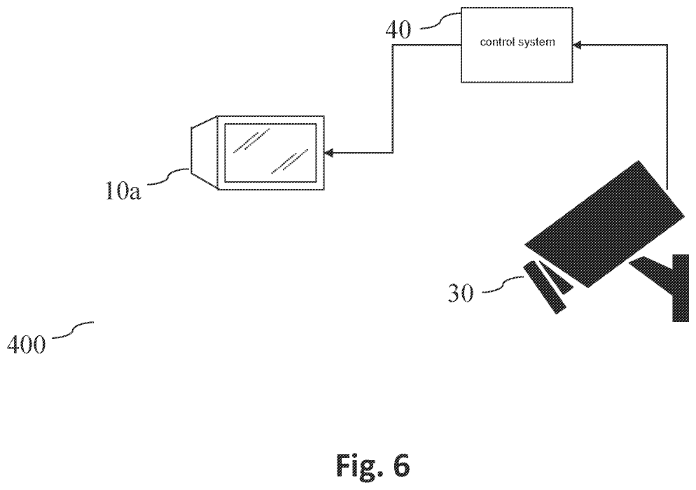

FIG. 6 shows one exemplary embodiment in which control system 40 is used for controlling a monitoring system 400. This exemplary embodiment differs from the exemplary embodiment shown in FIG. 5 in that, instead of actuator 10, display unit 10a is provided, which is activated by control system 40. For example, an identity of the objects recorded by video sensor 30 may be reliably ascertained by artificial neural network 60 in order to infer, e.g., which objects become suspect, and activation signal A may then be selected in such a way that this object is represented highlighted in color by display unit 10a.

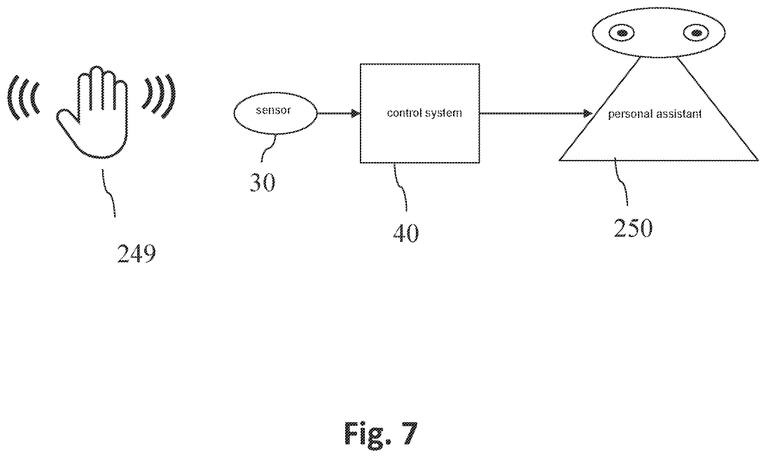

FIG. 7 shows one exemplary embodiment in which control system 40 is used for controlling a personal assistant 250. Sensor 30 is preferably an optical sensor which receives images of a gesture of a user 249.

As a function of the signals of sensor 30, control system 40 ascertains an activation signal A of personal assistant 250, for example in that the neural network carries out a gesture recognition. This ascertained activation signal A is then communicated to personal assistant 250, and it is thus accordingly activated. This ascertained activation signal A may then, in particular, be selected in such a way that it corresponds to a presumed desired activation by user 249. This presumed desired activation may be ascertained as a function of the gesture recognized by artificial neural network 60. Control system 40 may then, as a function of the presumed desired activation, select activation signal A for the communication to personal assistant 250 and/or select activation A for the communication to the personal assistant corresponding to the presumed desired activation 250.

This corresponding activation may, for example, include that personal assistant 250 retrieves pieces of information from a database, and reproduces them acceptable for user 249.

Instead of personal assistant 250, a household appliance (not shown), in particular, a washing machine, a stove, an oven, a microwave or a dishwasher may also be provided to be accordingly activated.

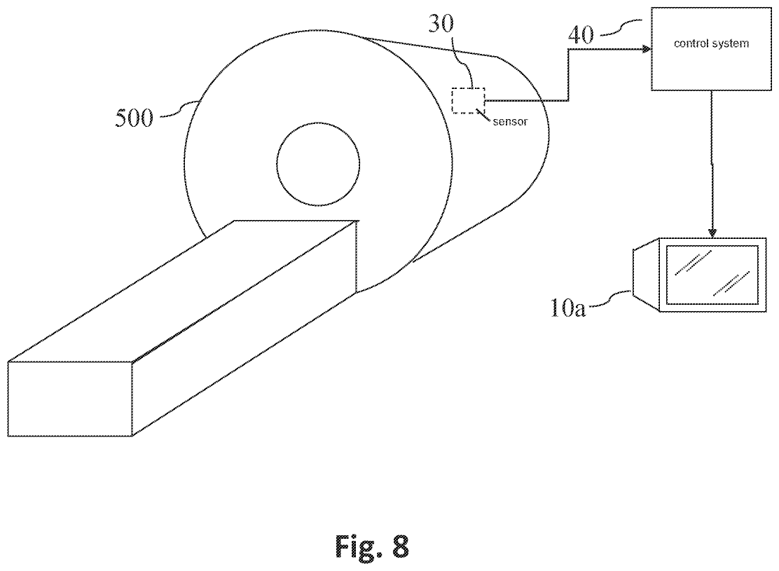

FIG. 8 shows one exemplary embodiment in which control system 40 is used for controlling a medical imaging system 500, for example an MRI, X-ray or ultrasound device. Sensor 30 may, for example, be an imaging sensor, and display unit 10a is activated by control system 40. For example, it may be ascertained by neural network 60 whether an area recorded by the imaging sensor is conspicuous, and activation signal A may then be selected in such a way that this area is represented highlighted in color by display unit 10a.

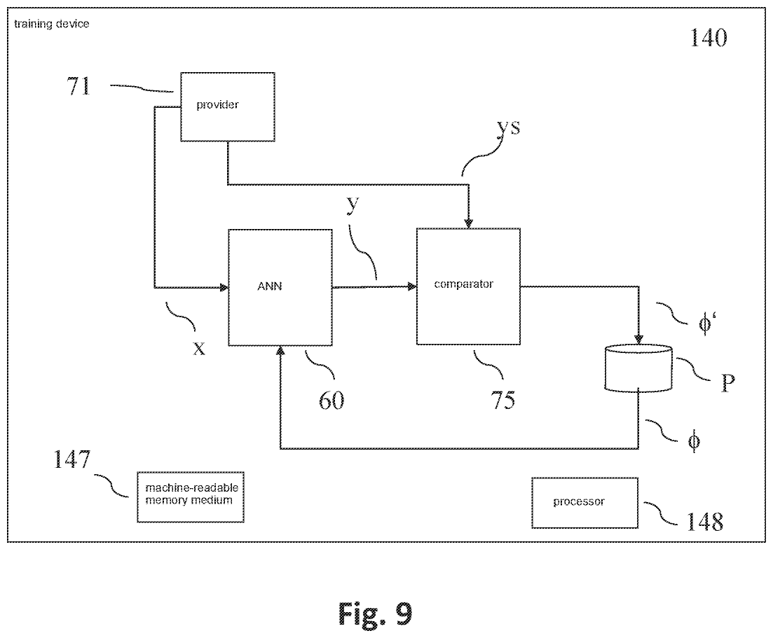

FIG. 9 shows an exemplary training device 140 for training one of the drawn machine learning systems, in particular of neural network 60, from the graph. Training device 140 includes a provider 71, which provides input variables x, such as, e.g., input images, and setpoint output variables ys, for example setpoint classifications. Input variable x is supplied to artificial neural network 60 to be trained, which ascertains output variables y therefrom. Output variables y and setpoint output variables ys are supplied to a comparator 75, which ascertains new parameters ϕ′ therefrom, as a function of an agreement of the respective output variables y and setpoint output variables ys, which are transferred to parameter memory P, and replace parameters ϕ there.

The methods executed by training system 140 may be stored on a machine-readable memory medium 147, implemented as a computer program, and executed by a processor 148.

Of course, it is not necessary to classify entire images. It is possible that, e.g., image sections are classified as objects using a detection algorithm, that these image sections are then cut out, possibly a new image section is generated, and inserted into the associated image in place of the cut-out image section.

The term “computer” encompasses arbitrary devices for processing predefinable computing rules. These computing rules may be present in the form of software, or in the form of hardware, or also in a mixed form made up of software and hardware.

What is claimed is:

1. A computer-implemented method for creating a machine learning system, comprising the following steps:
providing a directed graph including one or multiple input and output nodes, which are connected via a multitude of edges and nodes, a respective variable being assigned to each respective edge of the edges, which characterizes a probability with which the respective edge is drawn;
randomly drawing a multitude of subgraphs by the directed graph as a function of the respective variables, the respective variables being changed in the graph as a function of a distribution of values of the respective variables;
training a machine learning systems corresponding to the drawn subgraph, wherein during the training, parameters of the machine learning system and the respective variables are adapted so that a cost function is optimized; and
drawing a subgraph, as a function of the adapted respective variables, and creating the machine learning system corresponding to this subgraph.

2. The method as recited in claim 1, wherein, when a measure of the distribution of the values of the respective variables relative to a predefined target measure of a target distribution is greater, the respective variables are changed in such a way that edges having an essentially equal probability are drawn.

3. The method as recited in claim 1, wherein the change of the respective variables takes place as a function of an entropy of the directed graph, and a number of training steps which have already been carried out.

4. The method as recited in claim 3, wherein, when the entropy is greater than a predefined target entropy, a parameter by which the respective variables are changed is changed in such a way that it changes values of the respective variables, so that the probability distribution characterizing the respective variables has a lesser similarity to a uniform distribution, and when the ascertained entropy is smaller than the predefined target entropy, the parameter is changed in such a way that it changes values of the respective variables, so that the probability distribution characterizing the respective variables characterizes a uniform distribution.

5. The method as recited in claim 1, wherein the change of the respective variables takes place as a function of an exploration probability, the exploration probability characterizing a probability with which the edges are drawn either as a function of the respective variables assigned to the edges or with an essentially identical probability.

6. The method as recited in claim 1, wherein the change of the respective variables takes place using a temperature scaling.

7. The method as recited in claim 6, wherein, during the temperature scaling, the respective variables are scaled as a function of a temperature which is changed as a function of the distribution of the values of the respective variables.

8. A non-transitory machine-readable memory element on which is stored a computer program for creating a machine learning system, the computer program, when executed by a computer, causing the computer to perform the following steps:
providing a directed graph including one or multiple input and output nodes, which are connected via a multitude of edges and nodes, a respective variable being assigned to each respective edge of the edges, which characterizes a probability with which the respective edge is drawn;
randomly drawing a multitude of subgraphs by the directed graph as a function of the respective variables, the respective variables being changed in the graph as a function of a distribution of values of the respective variables;
training a machine learning systems corresponding to the drawn subgraph, wherein during the training, parameters of the machine learning system and the respective variables are adapted so that a cost function is optimized; and
drawing a subgraph, as a function of the adapted respective variables, and creating the machine learning system corresponding to this subgraph.

9. A device configured to create a machine learning system, the device being configured to:
provide a directed graph including one or multiple input and output nodes, which are connected via a multitude of edges and nodes, a respective variable being assigned to each respective edge of the edges, which characterizes a probability with which the respective edge is drawn;
randomly draw a multitude of subgraphs by the directed graph as a function of the respective variables, the respective variables being changed in the graph as a function of a distribution of values of the respective variables;
train a machine learning systems corresponding to the drawn subgraph, wherein during the training, parameters of the machine learning system and the respective variables are adapted so that a cost function is optimized; and
draw a subgraph, as a function of the adapted respective variables, and create the machine learning system corresponding to this subgraph.
